(19) United States
(12) Patent Application Publication
(10) Pub. No.: US 2009/0187474 A1
(43) Pub. Date: Jul. 23, 2009

(54) METHOD AND SYSTEM OF TRACKING, COORDINATING, AND QUANTIFYING CHARITABLE ACTIONS AND COMMUNITY SERVICE

(76) Inventor: Kip Longinotti-Buitoni, Mamaroneck, NY (US)

Correspondence Address: PRYOR CASHMAN, LLP, 410 PARK AVENUE, NEW YORK, NY, 10022, US

(21) Appl. No.: 12/356,304

(22) Filed: Jan. 20, 2009

Related U.S. Application Data
(60) Provisional application No. 61/011,431, filed on Jan. 17, 2008.

(51) Int. Cl. G06Q 50/00; G06F 17/30; G06F 17/40; G06Q 10/00

(52) U.S. Cl. 705/11; 707/7; 705/1; 707/E17.014; 707/E17.044

(57) ABSTRACT

A central and remotely accessible system of tracking, quantifying, and standardizing community service activity among a plurality of participants and service organizations is disposed on at least one central computer. The system includes a points tracking module adapted to receive logs of community service activity from participants and convert the logs into numerical values corresponding to the community service activity. A database is in communication with the points tracking module and adapted to accumulate the numerical values and sort the numerical values at least by respective participants. A first interface, remotely accessible by the participants and in communication with the points tracking module, is adapted to enable participants to enter the logs of community service activity. The first interface may also include a reflection tool enabling the participants to record subjective experiences associated with the logged community service activity, wherein the numerical values are adjustable based on the recorded experiences.

Domestic priority is claimed from U.S. Provisional Patent Application No. 61/011,431 filed Jan. 17, 2008 entitled “Method and System of Tracking and Coordinating Charitable Actions”, the entirety of which is incorporated by reference herein.

### BACKGROUND OF THE INVENTION

1. Field of the Invention

The invention is related to systems of tracking the actions of people, and more particularly to a system and method of tracking, coordinating, and quantifying the actions of people donating their time and energy to charitable causes and other similar endeavors.

2. Description of Related Art

Many school districts, religious organizations, and even cities and towns are becoming increasingly interested in getting their various members more involved in public or community service. In some cases, for example, for children in school (be it secular or religious), a public service requirement is mandatory for graduation or promotion to the next grade or level.

Yet despite the great interest and clear need for greater personal involvement in charitable and public service, there is a lack of consistent organization or tracking of such programs. For one, should a student transfer in from another school district, often previous community service remains undocumented or poorly documented, and the student fails to be recognized properly for her previous efforts. Second, there is usually no way for participants to choose an alternate charitable work other than the one or two selected by the school/church. Third, it is sometimes difficult for even the school/church to select one charity to assist. Moreover, there is no consistent accurate manner for the participants to earn credit for their activities. Colleges and graduate schools often value community service on an applicant's resume, however there currently is no mechanism for a college to determine quantitatively how much service a person has contributed. Finally, some charities and organizations are national or global in scale and offer many people the opportunity to serve; there is a long-felt need to provide a forum for widely-flung participants for the same cause to communicate with each other, even if they have never met.

### SUMMARY OF THE INVENTION

The invention fulfills the above and other needs by providing a system and method of coordinating and tracking charitable service contributions. A central tracking system coordinates information among various charitable causes (“charities”), students or other participants (“participants”), mentors to or other supervisors of the participants (“supervisors”), and requesters of data concerning the activities of the participants (“data requesters” or “third party data requesters”). One or more charities subscribe to the central tracking system to enable participants to become aware of the charities and to select one or more charities and projects thereof to whom to contribute service. The participants are preferably matched up (not necessarily in one-to-one correspondence) with a supervisor, either from the charity or independent therefrom.

Upon conclusion of an activity (either at the end of a given day, week, or other time period, or at the end of a project), the participant logs her activity on the central tracking system. In the preferred embodiment, the participant logs her activity directly with the central tracking system; in alternative embodiments, the participant logs her activity either with the charity or with a supervisor, and the charity or supervisor enters the data with the central tracking system (thereby providing a layer of oversight to ensure honesty in reporting). Approval of logged activity is preferred in any event. Activity is converted into a numerical value, e.g., one hour of time may equal one or more “points”, one project may equal one or more points, or the like. Certain activities may have greater points values than others, e.g., travel time to a project may be worth fewer points per hour than the actual project work itself. Different weighting may be applied to different types of time spent (e.g., travel to a project may only receive a fraction of the weighting of the time spent on the project itself). Each participant has an account into which said points are accumulatable. Numerical values of activity may also be adjustable upon evaluation of the participant's “evolution” from before the activity to after the activity, thereby measuring how the participant matured or improved himself or his outlook as a result of the community service.

The participant can check his account to see how far along he is in meeting a personal goal or an externally imposed requirement. Additionally, subscribing data requesters can check or verify with the central tracking system how much service a given participant has performed in an objective, quantifiable manner. Participants may use the central tracking system also in a social networking capacity to reach out to other participants and/or supervisors, either in the same region, working for the same charity, or in accordance with other parameters.

In a preferred embodiment, the invention is a system of tracking and standardizing community service activity among a plurality of participants and service organizations. A central and remotely accessible tracking system is disposed on at least one central computer and includes a points tracking module adapted to receive logs of community service activity from participants (or from supervisors) and convert the logs into numerical values corresponding to the community service activity. A database is provided in communication with the points tracking module. The database is adapted to accumulate the numerical values and sort the numerical values at least by respective participants. At least a first interface is remotely accessible by the participants and is in communication with the points tracking module, adapted to enable the participants to enter the logs of community service activity. The database is further adapted to sort the numerical values by at least one of: i) a grouping of the participants or ii) the service organizations on behalf of which the community service activity was performed. The grouping of participants may be by at least one of demography, geography, or class.

Preferably, the database is in communication with the first interface, and the first interface further enables the participants to select from a plurality of the service organizations for which the participants wish to perform community service activity. The first interface may preferably include an account section informing the participant how much community service activity the participant has logged in the system. The account section may also inform the participant of the numerical values assigned to the logs of community service activity.

The central tracking system preferably includes up to three additional interfaces, in any combination. A second interface may be provided remotely accessible by supervisors of the participants and in communication with the points tracking module, adapted to enable the supervisors to view and approve or reject the logs of community service activity entered by the participants. A third interface may be provided, remotely accessible by the service organizations and in communication with at least one of the points tracking module and the database, adapted to enable the service organizations to monitor progress of the participants. The third interface may also enable the service organizations to create and upload service projects storable on the database from which the participants may select to perform the community service activity. A fourth interface may be provided, remotely accessible by third party data requesters and in communication with at least the database, adapted to enable the third party data requesters to view at least one of the logs of community service activity or the numerical values, corresponding to selectable participants.

Optionally, the points tracking module may assign different numerical values to different types of community service activities. The points tracking module may also include a qualitative points weight manager adapted to enable adjustment of the numerical values by at least one of supervisors of the participants or the service organizations. The qualitative points weight manager may also enable adjustment of the numerical values for different participants differently, based on at least one variable associated with the participants. One such variable is concerned with the growth or evolution of the participant from a pre-service state to a post-service state. In utilizing an evolutionary variable in this manner, the first interface preferably includes a reflection tool enabling the participants to record subjective experiences associated with the logged community service activity (i.e., reflect on their service); the numerical values may be adjustable via the qualitative points weight manager based on the recorded experiences and based on a comparison of a pre-service snapshot or state of the participant to a post-service snapshot or state.

Weighting of the numerical values associated with various types of community service activity can also be accomplished by the provision of institutional profiles stored on the database, the profiles containing instructions to pre-weight preferred community service activities. The profiles are preferably remotely configurable by at least one of the supervisors, the service organizations, or the third party data requesters via their respective interfaces.

As mentioned above, the numerical values assigned to logged community service activity may represent the length of time spent on the community service activity by the participant (subject to adjustment by the qualitative points weight manager or other similar mechanisms).

### BRIEF DESCRIPTION OF THE DRAWINGS

FIG. 1 is a schematic of the overall architecture of a charitable service tracking system in accordance with the invention.

FIG. 2 is a schematic of one embodiment of the architecture of a website of a charitable service tracking system in accordance with the invention.

FIG. 3 is a schematic of one embodiment of a screenshot that a participant may view and interface with in accessing her account.

FIG. 4 is a logic flow chart depicting creation of a reflection tool by an administrator in accordance with the invention.

FIG. 5 is a logic flow chart depicting one embodiment of the invention requiring a reflection tool of a participant by a supervisor, the subsequent completion of the reflection tool by the participant, and the further subsequent review of the reflection tool by the supervisor.

FIG. 6 is a logic flow chart depicting the qualitative review process of a completed reflection tool and its potential quantitative effect on the numerical value of the participant's logged community service.

FIGS. 7A-F are exemplary screenshots depicting various interfaces to be employed in accordance with the invention.

FIGS. 8A-B depict an example of a reflection tool in accordance with the invention.

### DETAILED DESCRIPTION OF THE INVENTION AND DRAWINGS

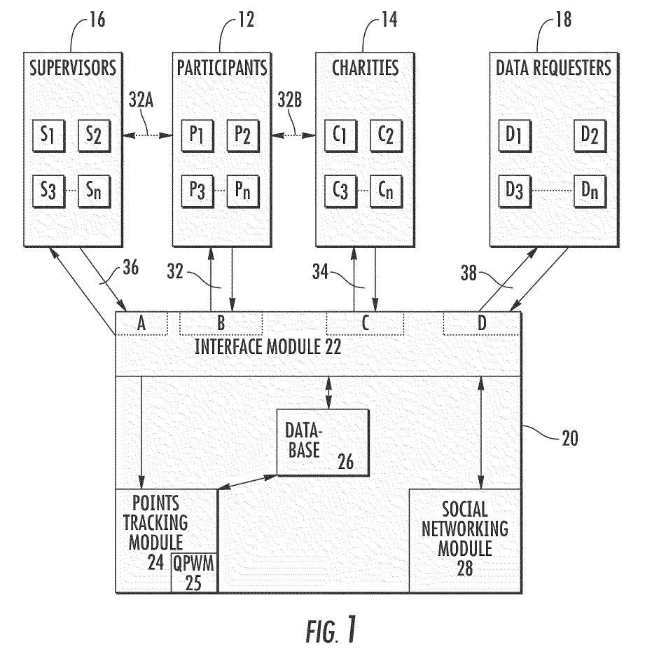

Description of the invention will now be given with reference to FIGS. 1-8. It should be understood that these figures are exemplary in nature and in no way serve to limit the scope of the invention, which is defined by the claims appearing hereinbelow.

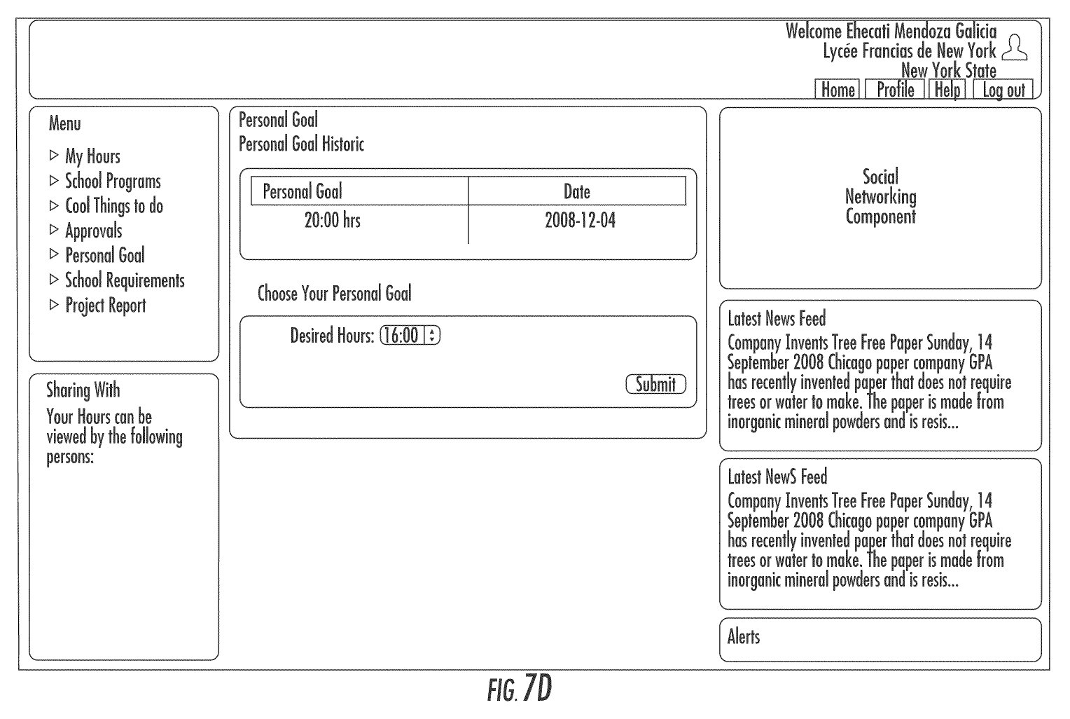

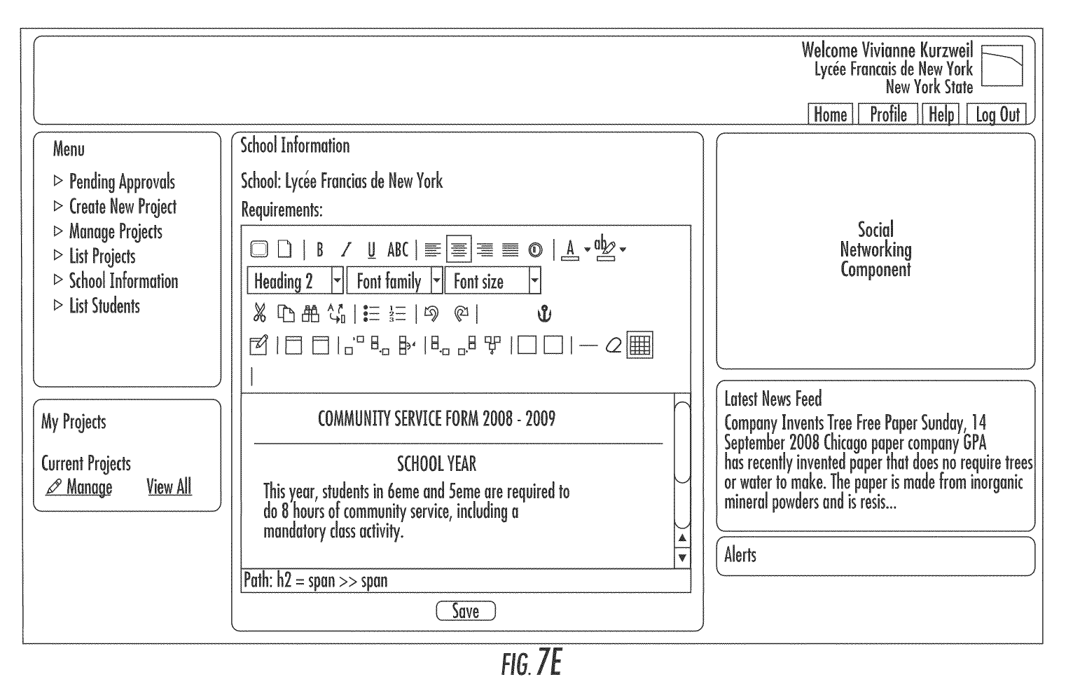

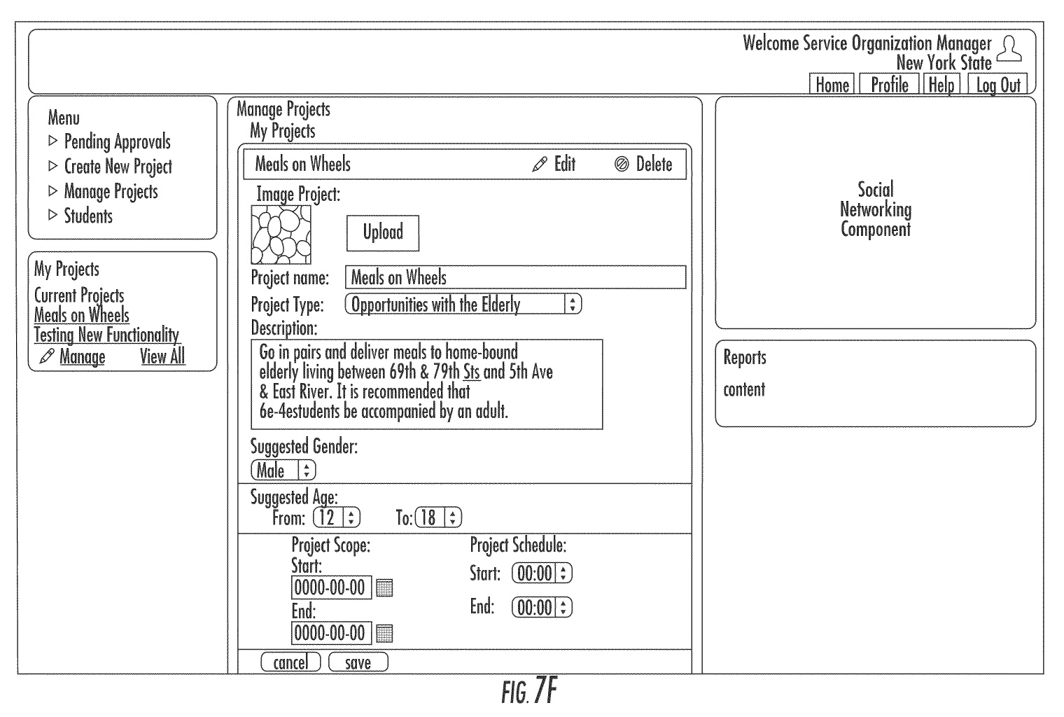

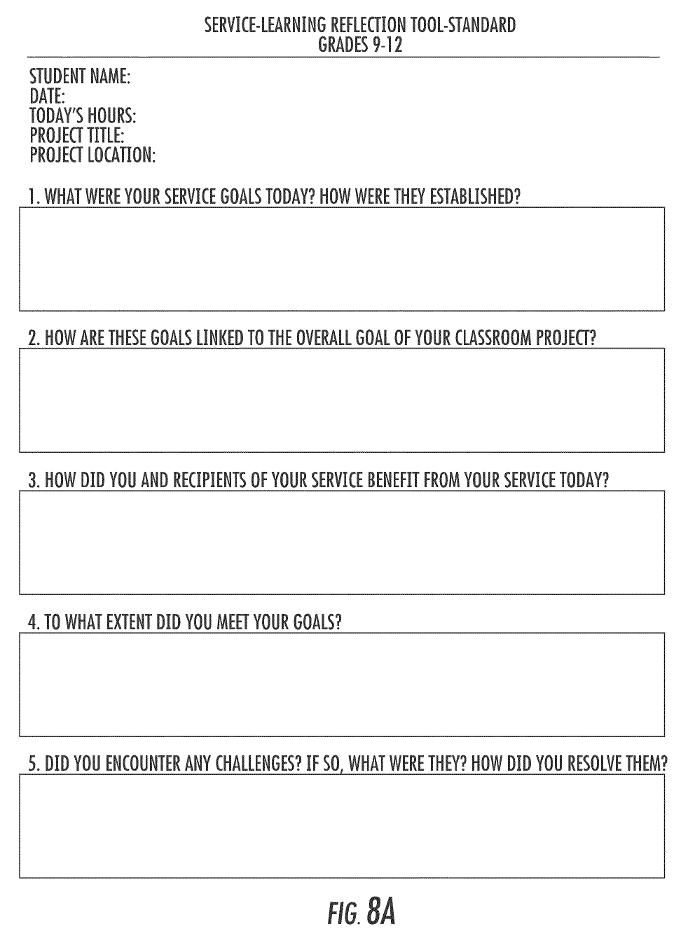

As shown schematically in FIG. 1, the inventive system has at its hub central tracking system 20 which coordinates information among various entities (as defined above): participants 12, charities 14, supervisors 16, and data requesters 18. One or more charities 14 subscribe to the central tracking system 20 to enable participants 12 to become aware of the charities and to select one or more charities and/or projects thereof for whom to contribute service. For a periodic subscription fee, a one-time payment, or other payment models, each charity 12 (represented as C1, C2, C3, . . . Cn individually) is listed on central system 20 so that a participant 12 (P1, P2, P3, . . . Pn individually) can log onto central system 20 and see to which charity or charities he would like to donate his time and/or services (see, e.g., FIG. 7A, an exemplary screenshot of a student participant selecting a project). Charities 14 can also be given dynamic access to the system so as to create and upload one or more specific projects (see, e.g., FIG. 7F, exemplary screenshot of charity administrator creating a project). If the given participant 12 comes from the general population, he might be presented with all of the subscribing charities and their respective projects, and/or be provided with a search engine so that he may be able to narrow down the list of charities 14 to a specific genre, region, by keyword, or the like. If the given participant 12 is a student in a school, for example (or any other member of a defined group of people), a much smaller list of charities or projects may be pre-selected by the principal or head of the group.

If a participant 12 is a child, he is preferably matched up with a supervisor 16 for purposes of interfacing with the charity and to assist in verifying or approving (and perhaps also recording) logged activity (see, e.g., FIG. 7E, exemplary screenshot of supervisor editing the requirements of her participant charges, and FIG. 7C, exemplary screenshot of supervisor approving or rejecting service time logged by a participant). A supervisor 16 (S1, S2, S3 . . . Sn, individually) may take the form of an adult (e.g., a teacher, counselor, parent, etc.) or an older child who has been through a round of the program already. A supervisor 16 may also be provided directly from the charity or independent therefrom. Other than school children, it is contemplated that adult participants may also benefit from and/or require supervision, e.g., prison inmates attempting to exhibit “good behavior”, public offenders required to perform community service, military personnel seeking to achieve a higher rank, corporate employees and job seekers seeking a higher (starting) salary, etc. This list is meant to be exemplary and is by no means exhaustive.

The other potential entities in the system are data requesters 18 (D1, D2, D3, . . . Dn individually). Typically, data requesters 18 may be third parties interested in determining the activity level of a given participant or participants. For example, a college or university may be able to request the activity level of a given participant 12 (as represented by the accumulated points in the participant's account) for purposes of determining community service activity or for verifying the participant's independent self-reporting of his community service activity to the college. Alternatively, a data requester may be the central office of a national or international group (e.g., the Boy Scouts of America, Freemasons, etc.) that has various chapters; the central office could thus track individual participant's activity levels or the levels of entire chapters, regions, states, etc. It is contemplated that data requesters 18 will subscribe to have access to central tracking system 20. Payments for access to the data by third party data requesters may be made periodically, on a per-request basis, or along any other financial model.

Description will now be provided for the central tracking system 20. All of the participants 12, charities 14, supervisors 16, and data requesters 18 access central tracking system 20 via an interface module 22. Each type of entity is preferably provided with a different type of interface (e.g., A-D) as would be appropriate for that entity. For example, participants 12 may interact with one interface B from interface module 22 while data requesters 18 may interact with a very different interface D. The various interfaces of interface module 22 may each include one or more application programming interfaces (APIs), or graphical user interfaces (GUIs), or simply different web pages or websites, or the like, either known now or to be developed in the future. Examples are shown in FIGS. 7A-F. Advertising may be solicited for the various interfaces. Each entity preferably accesses interface module 22 via a respective communication link 32, 34, 36, or 38. Additionally, participants 12 may be required to log their activity through either supervisors 16 or directly to charities 14, via communication links 32A or 32B, respectively. All of the communication links listed above may be internet-based, dedicated lines, or via any other conventional communications devices or systems either known now or to be developed in the future.

Central tracking system 20 includes a points tracking module 24, which receives logged activity from or on behalf of participants 12 (or charities 14 or supervisors 16) via interface module 22, converts the logged activity into a numerical value (“points”), and associates the numerical value with the specific participant. In other words, each participant is preferably provided with a separate account of service points that can be accumulated toward a specific threshold. Alternatively, a group of participants (e.g., a class in a school or youth group) can be provided with a single account into which all of the constituent participants' points are aggregated. It is contemplated that the points tracking module employ a database module 26 that can sort and aggregate points and accounts based on any number of parameters, including grouping participants by class, age, region, state, organization, charity, chronologic periods (by specific days, weeks, months, years, etc.), or the like. Points tracking module 24 may be integral with database 26 or it may be separate.

It is recognized that not all community service time spent is equal: as an example, an hour spent traveling to a site may not be ‘worth’ as much to the community or to the growth of the participant as an hour actually performing an activity. Indeed, certain activities may be worth more than others to certain participants or to certain data requesters. As an example, picking up trash on the side of a road is valuable to a community but perhaps not so spiritually challenging as visiting the elderly or sick. As such, it is contemplated to be able to weight different activities differently. To achieve this goal, points tracking module 24 may also include a qualitative points weight manager 25 that enables adjustment of the numerical values by at least one of supervisors of the participants or the service organizations. That is, points weight manager 25 may provide supervisors 16 or charities 14 the ability to set different numerical values for participants' time, and not merely assign a 1 point per 1 hour value to all time equally. Supervisors 16 or charities 14 may enter points tracking module 24 and, using the points weight manager 25, manually adjust the numerical value associated with entire types of service activity, or even adjust the value based on much more specific criteria. Weighting of the numerical values associated with various types of community service activity can also be accomplished automatically by the provision of institutional profiles stored on the database, the profiles containing instructions to pre-weight preferred community service activities. The profiles are preferably remotely configurable by at least one of the supervisors, the service organizations, or the third party data requesters via their respective interfaces. For example, a supervisor of participants for a charity preparing and delivering food to the homebound may set up instructions to weight travel time as 0.5 points/hour, food preparation as 1 point/hour, and spending time with the homebound as 1.25 points/hour.

The qualitative points weight manager may also enable adjustment of the numerical values for different participants differently, based on at least one variable associated with the participants. Some participants may find certain activities more challenging than others, and in the overcoming of those challenges, the participant may get more out of that activity than someone who finds it easy (e.g., public speaking may be easy for a member of the debate team but difficult for a shy person).

One such variable is concerned with the growth or evolution of the participant from a pre-service state to a post-service state. In utilizing an evolutionary variable in this manner, the first interface preferably includes a reflection tool enabling the participants to record subjective experiences associated with the logged community service activity (i.e., reflect on their service); the numerical values may be adjustable via the qualitative points weight manager based on the recorded experiences and based on a comparison of a pre-service snapshot or state of the participant to a post-service snapshot or state. In other words, if a participant can demonstrate personal growth from her community service (rather than merely “doing her time” to fulfill a mandatory requirement), her supervisor can adjust the point value accordingly. As an example, a juvenile offender who is court-ordered to pick up trash on the side of the road may merely be logging her time and fulfilling her hourly requirements, exhibiting neither remorse nor reflection about her infraction or her service. However, a juvenile offender who is court-ordered to repair vandalism he perpetrated on a church might demonstrate personal growth by reflecting on his actions and interacting with members of the community. The reflection tool is designed to capture the participant's reaction to the experience and allow a supervisor to adjust the numerical value of his service based on that reaction. Optionally, the participant's initial expectations and feelings prior to the community service are also captured in a pre-service reflection tool to reflect the state of the participant before service, which can be compared to his state after service.

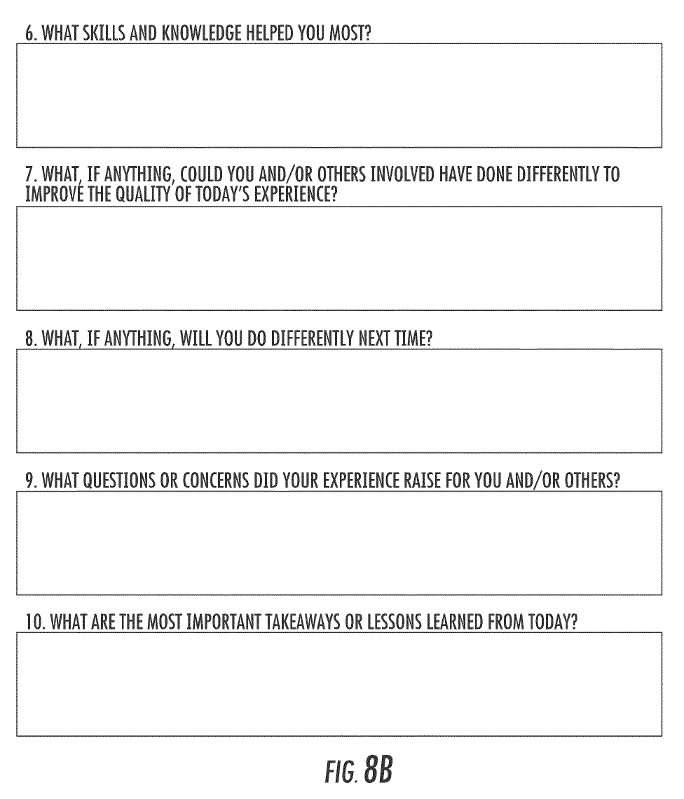

The process of creating, implementing, and using a reflection tool for point adjustment is shown in FIGS. 4-6. In FIG. 4, the supervisor 16 or an administrator from charity 14 creates a reflection tool at step S1, logs into the system 20 via interface module 22 (either interface A or C, for example) at step S2, and describes the file associated with the tool in step S3. The submitter is queried at step S4 if the type or category of reflection tool being submitted already exists, e.g., a standard form to fill out (see, e.g., FIGS. 8A-B), a more open-ended creative writing reflection, or an even more open-ended artistic reflection involving drawings, photography, music, graphics, etc. If a relevant category does not exist, a new category is created at step S5. If a relevant category already exists, that category is selected at step S6, and the submitter browses for and uploads the reflection tool in steps S7 and S8, respectively. The reflection tool is now ready for use.

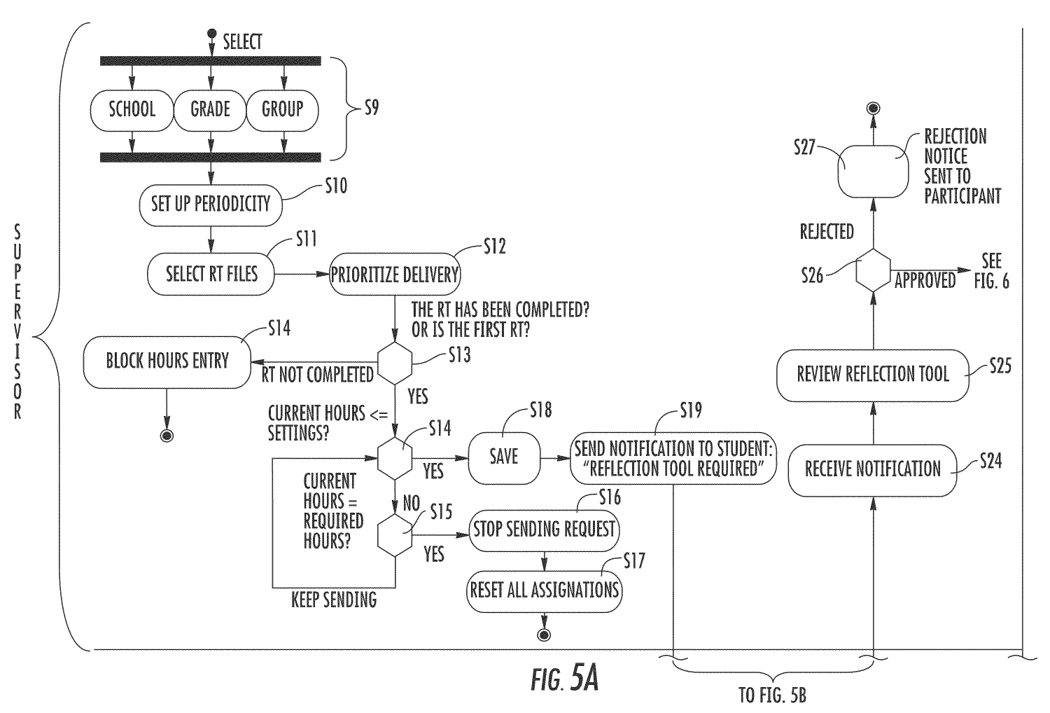

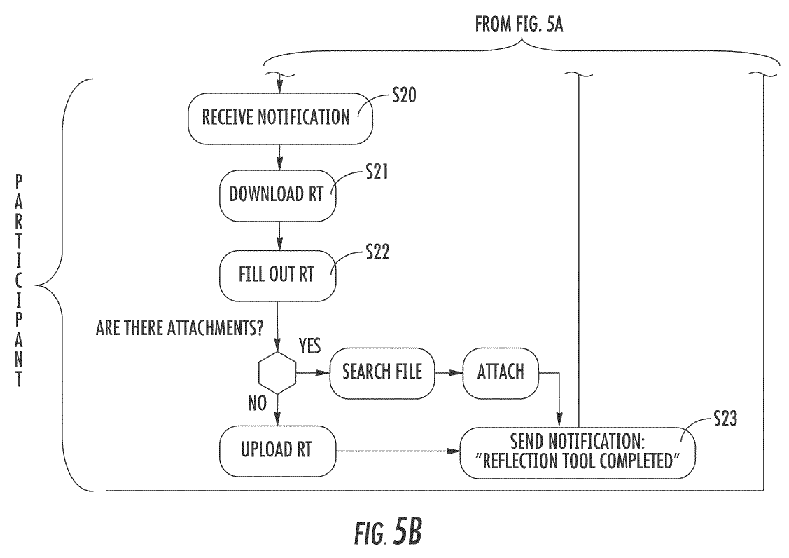

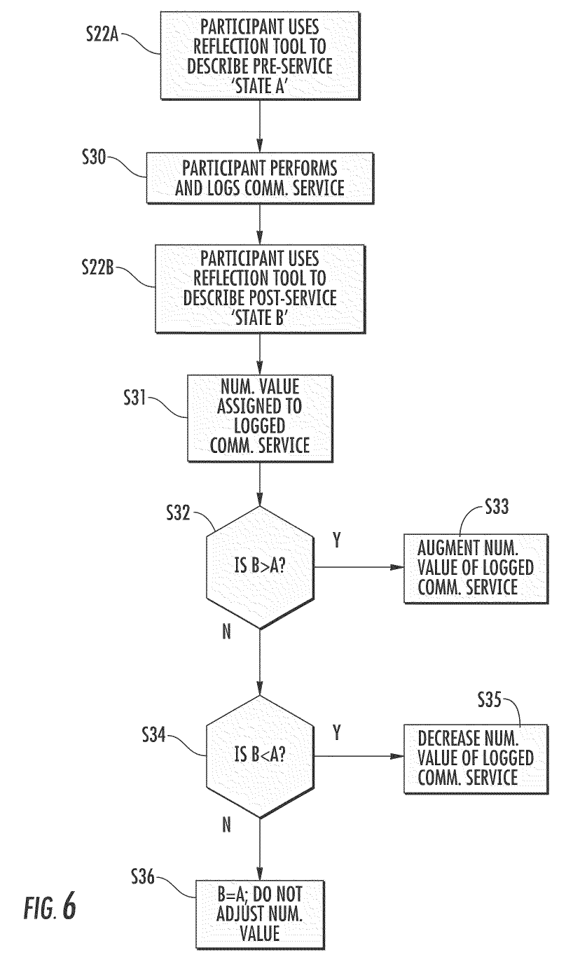

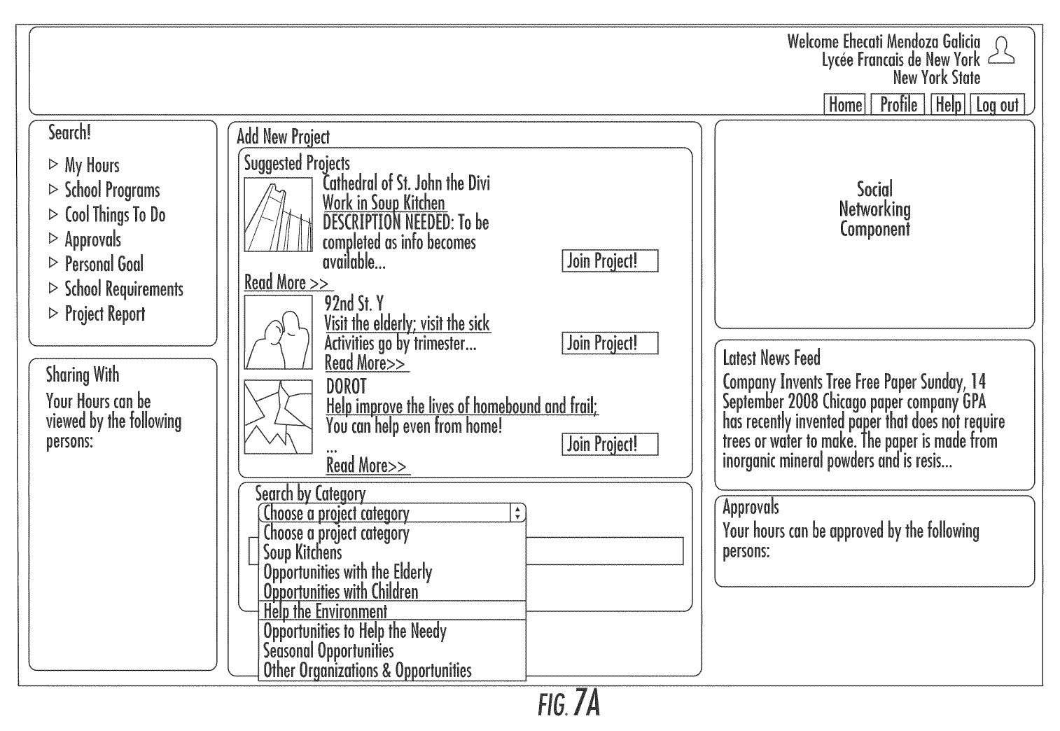

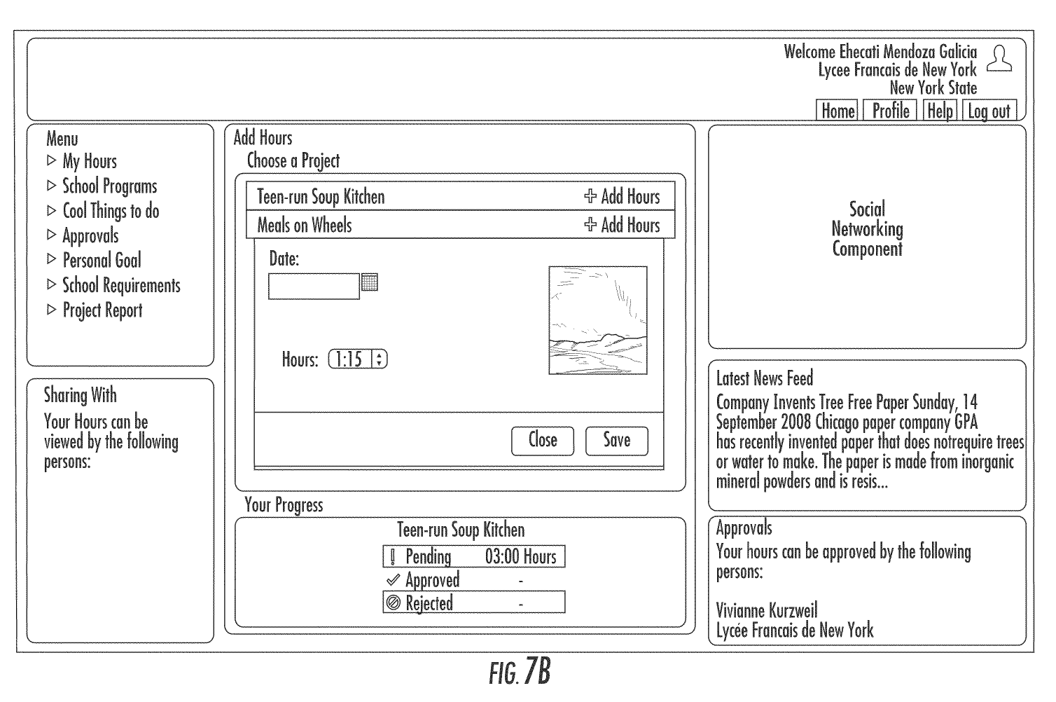

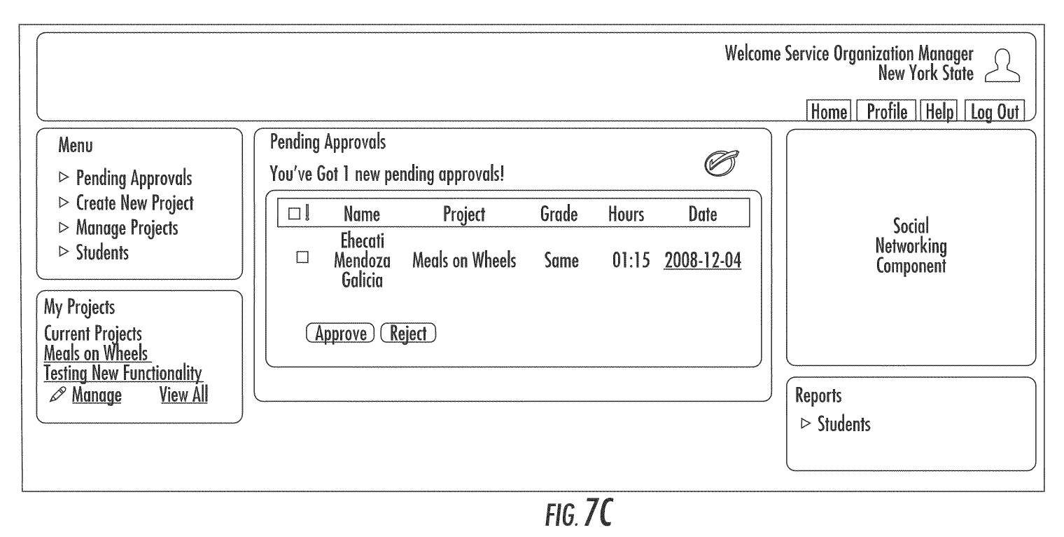

FIG. 5 depicts the actions taken at the supervisory and participant levels with respect to the reflection tool (or “RT”). The supervisor selects a demographic/classification of participants (e.g., school, grade, group) in step S9 she would like to associate with a given RT, determines how often it needs to be completed by a participant at step S10, and selects which specific reflection tool or tools are to be used at step S11. Delivery prioritization is effectuated at step S12. If at step S13 it is determined a given participant's RT has not been completed or if it is her first RT, the participant's hours are denied approval at step S14. If an RT is complete, then the system determines if the participant has met certain activity hours or points benchmarks (e.g., periodic settings such as completion of a certain number of hours or steps in a project, in step S14, overall required hours in step S15). If overall required hours are met, the request is no longer sent at step S16 and the values are reset at step S17. If not, current hours are saved at step S18, and notification is sent to the participant that an RT is required at step S19.

The participant receives notification that an RT is required at step S20, downloads the RT at step S21, and completes it at step S22 (which may involve uploading attachments). Thereafter, the participant sends notification to the supervisor that the RT is complete at step S23. The supervisor receives this notification at step S24 and reviews the RT at step S25. The RT is either accepted or rejected at step S26. If it is rejected, a rejection notice is sent to the participant in step S27. If the RT is approved, then the participant's hours are approved.

A qualitative assessment of the participant may optionally occur based on RT review and/or approval as shown in FIG. 6. As described above, a participant will complete an RT to describe her state of mind, her expectations, and such before performing the community service activity (her pre-service ‘State A’) in step 22A. She then performs and logs the community service activity in step S30. After the activity is performed and logged, she completes another RT to describe her state of mind, reflections, frustrations, lessons learned, etc. after the service activity (her post-service ‘State B’) at step 22B. A numerical value is initially automatically assigned to the logged community service by points tracking module 24. At this point, a supervisor or other similar entity compares the participant's pre-service state A to her post-service state B at step S32. If the supervisor determines that the participant has come away with valuable lessons, has grown as a person (i.e., B>A), then the numerical value of the logged community service is augmented via application of the qualitative point weight manager at step S33. If for some reason, the participant exhibits negative personal growth, a regression to negative attitudes or behaviors (i.e., B<A), the numerical value of the logged community service may be decreased in step S35. Otherwise, if the participant exhibits neither growth nor regression (she's “just doing her time”), then the numerical value is not qualitatively adjusted in step S36. Of course, some programs or supervisors may require a participant to exhibit personal growth; in such an instance, the thresholds for increasing, decreasing, or maintaining the numerical value of logged service can be adjusted.

As an optional component of system 20, various participants 12 can communicate with each other via social networking module 28. This gives participants and ‘alumni’ the opportunity to converse about the program, what they learned from it, or anything at all. Each participant 12 may be given the opportunity to create her own virtual space which other participants may visit. Tags on the participant's virtual space may indicate to other participants what project or charity the participant was working on or for, where they are located geographically, their age, common interests, and the like. For example, participant P1 may be reading to the blind in Atlanta, Ga., and participant P2 may be reading to the blind in Poughkeepsie, N.Y. Participant P3 might also reside in Atlanta but be delivering meals to the elderly. These participants might have a lot to discuss with each other about their community service, themselves, or other topics.

In operation, the invention works as follows. A number of charitable and community service organizations subscribe to the central system and create and upload a number of community service projects in which individuals may participate (see, e.g., FIG. 7F, exemplary screenshot of a service organization manager from charity 14 creating and managing a project). A participant 12 logs onto the system 20 through interface A of module 22 via communications link 32. If the participant 12 is from the general population, he may browse through a listing of subscribing charities 14 and their respective projects, or he may search via one or more search parameters to find charities or projects in which he might be interested (see FIG. 7A). Optionally, for each charity or project, a participant can review the weighting of time spent, i.e., how many points each activity earns the participant per hour. Once a participant 12 has selected a charity for which to perform a service, he physically has to perform the service, be it reading to the blind, cleaning a roadside, visiting a shut-in, delivering a meal to a poor or elderly person, etc. Upon conclusion of his activity (either at the end of a given day, week, or other time period, or at the end of a project), participant 12 logs his activity on central tracking system 20 (see FIG. 7B, participant logging hours into central system 20). In the preferred embodiment, the participant logs his activity directly with the central tracking system 20. The participant would interact with an interface from interface module 22, which would transmit the reported activity data to points tracking module 24. The hours submitted by the participant would need to be approved by either charity 14 or supervisor 16 (see FIG. 7C, supervisor reviewing and approving/rejecting hours submitted by participant). In alternative embodiments, the participant logs his activity either with the charity 14 or with a supervisor 16, and the charity or supervisor enters the data with the central tracking system (thereby providing a layer of oversight to ensure honesty in reporting).

Regardless of whom actually logs the data, the data is entered into the points tracking module 24, where activity is converted into a numerical value, e.g., one hour of time may equal one point, one project may equal one point, or the like. As discussed above, the numerical value is variable and adjustable, depending on geography, demography, or other variables associated with the participants. Each participant 12 has an account recorded in database 26 into which said points are accumulatable. The participant can check his account to see how far along he is in meeting a personal goal (see FIG. 7D) or an externally imposed requirement. Additionally, data requesters 18 can check or verify with the central tracking system how much service a given participant has performed in an objective, quantifiable manner. Supervisors 16 optionally may create web pages for their respective participants 12 to visit so that the participants' learning process is enhanced. Participants 12 may send content (photos, letters, etc.) either directly to such web pages or to their supervisors 16 for inclusion on their virtual community space.

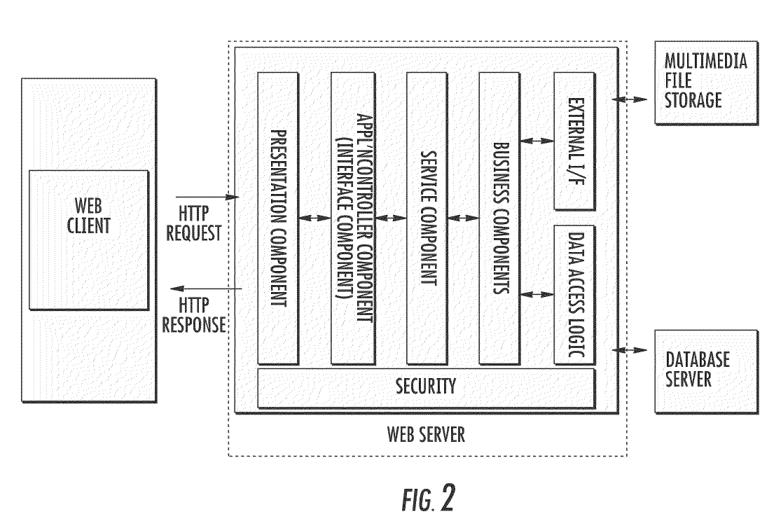

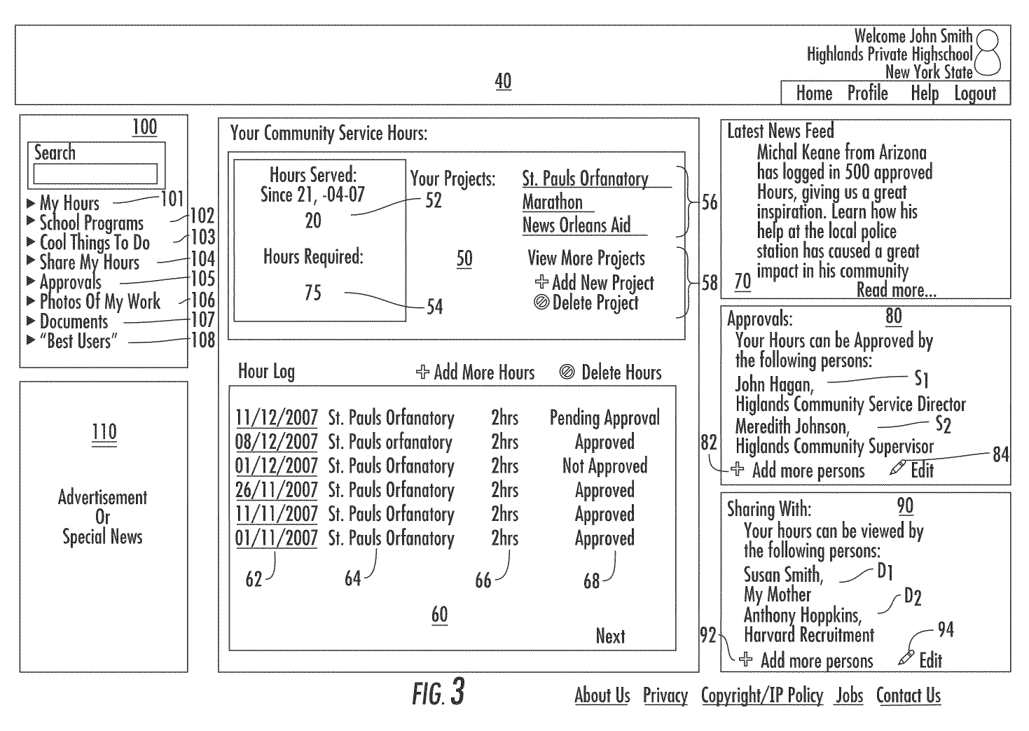

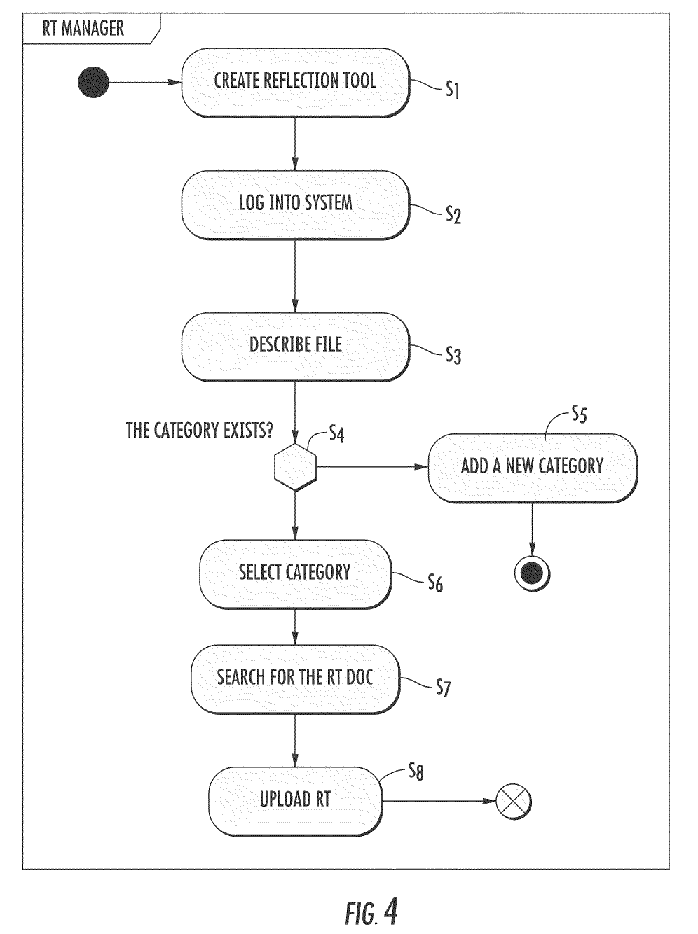

FIG. 2 illustrates one embodiment of the architecture of a website that can operate within the inventive framework. Any specific listings of software, logic, or the like are merely exemplary and should not be understood to be exclusive in nature.

The architecture is preferably divided into the following layers:

View/Presentation Layer, Control Layer, Business Layer, Persistence Layer. The advantages of the layered design are found in the maintenance and evolution stage of the application's lifetime. As technologies and functionality requirements change over time, it is much easier to adapt the layered application than it is a single layered design as the functionality is segregated into several separable layers.

### Presentation Layer

This layer in the website is presented as a Web Form. The presentation layer is required to enable user interaction with the application. This layer consists of a number of elements on a form that display data and accept user input. This layer is responsible for validating the user inputs at client side. A library of scripts conducts the basic validations such as verifying that the mandatory fields are filled, date format etc. This application verifies and prompts if necessary that the Java script is enabled on client's browser.

### Control Layer

The Page Controller pattern applies the controller at the level of individual pages. The runtime code intercepts page requests, invokes the requested actions on the server side objects, and determines the correct view to use for the resulting page. The controller is used to forward request for the desired action. All the user inputs are validated at this layer using validation helpers. Server side validations check the validity of data for example replacing all instances of single quotes with two single quotes for database inputs etc.

Business Layer

Service Interface

The service interface is used to provide a consistent interface to the underlying business objects and isolate the client from changes to the underlying business logic. The service interface acts as a Façade for Business Logic and passes the XML or structures retrieved from Business layer to page controller. Any application functionality can be exposed as a web service from this layer. All transactions are controlled from this layer.

Interface Implementation

The business logic is preferably implemented as class libraries. The business rules are implemented in this layer. This layer retrieves data from DAO layer in the form of generic objects or Value Objects as the case may be and sends the formatted data to service layer in the form of structures. Business entities like messages, events, deliverables etc are represented by classes in this layer.

Persistence Layer

This layer is used for data access logic and provides methods to perform create, read, update, and delete data on the database. All the stored procedures are formed and executed from this layer.

### Multimedia Compatibility

Multimedia files that are uploaded by the end user are preferably converted to a Macromedia Flash compatible file (or a similar uniform format) and are stored on a physical hard drive. The metadata for the media files are stored in the website database and are used to enable retrieval of the media file.

As mentioned above, a participant is likely to use the system over the internet and would thus require an interface generated by interface module 22. One embodiment of a participant-level interface is depicted in FIG. 3 as web page 40, which comprises several fields 50-110. Of course, any of these fields may be broken down into two or more fields, and any of the existing fields may be combined to form larger fields.

Field 50 as depicted in FIG. 3 summarizes for the participant his overall status within the program. Accumulated hours 52 and total hours required 54 are shown. Additional numerical representations, such as hours remaining before the participant reaches a certain level or achievement, may also be depicted. A list 56 of all charities or projects the participant is working on is presented. Operators 58 allow the participant to add additional projects to his account, delete existing projects, or view other projects.

Field 60 depicts a detailed listing of the hours the participant has entered into the system, either himself or by his supervisors on his behalf. Various columns are shown: column 62 reflects the date of the hours, column 64 reflects the project or charity, column 66 the number of hours spent on that date, and column 68 represents the status of the entered hours. “Approved” hours have been accepted by a supervisor; “not approved” have not (perhaps the participant was not actually present that day or performed an activity that did not count towards the project); “pending approval” are awaiting acceptance by a supervisor. Tools 61, 63, and 65 allow the participant to add or delete hours, or to view additional sets of hours logged. In the example shown in FIG. 3, all of the hours are for the same project or charity. By clicking on the “Next” button 65, the participant may be able to view the time spent on other projects, during different date ranges, etc.

Field 70 may include news about various charities and projects in the system, including the ones the participant works on as well as any other he may wish to subscribe to for news.

Field 80 shows the participant who her supervisors 16 are who can approve the time entries she enters into the system. As with other fields, field 80 includes operator tools 82 and 84 for editing and revising the list of approved supervisors.

Field 90 shows the participant who is allowed to view his account, e.g., data requesters 18. In the examples shown, D1 represents the participant's mother, and D2 represents a college admissions officer. As with other fields, field 90 includes operator tools 92 and 94 for editing and revising the list of approved data requesters.

Field 100 provides a number of links for the participant to click on for additional functionality. “My hours” link 101 may bring the participant to the webpage shown in FIG. 3 or a different page showing a breakdown of how many hours are logged for each event or project. “School programs” link 102 may bring the participant to a webpage showing the charities and projects that are approved or mandated in that participant's school, district, or the like. The “cool things to do” link 103 may give some suggestions for activities in which the participant may engage outside of the program. “Share my hours” link 104 and “approvals” link 105 function similarly to the operators 82, 84, 92, and 94 of fields 80 and 90, respectively; that is, they provide an interface through which the participant can add, delete, and edit supervisors 16 or data requesters 18. “Documents” link 107 enables the participant to upload or edit essays, photos, videos, etc. about the project or charity he is working for and his thoughts about same. Documents link 107 may also take the participant to a common bulletin board style page where the documents of multiple participants can be viewed. These participants can be grouped by classroom, by school, by state, by charity, or by other demographic classifications. “Best Users” link 108 can be used as a “hall of fame” board on which the participants with the greatest number of hours, the greatest diversity in projects, the most moving essay/video, etc. can be recognized on a daily/weekly/monthly (or other time period) basis. Additional links or other functions may be added.

Field 110 can be used for advertising or other information. Advertising may take the form of ads from the various charities, ads for products in which the participants might be interested, or any other form of web-based advertising known now or contemplated in the future. Other information may include trivia questions, games, surveys or polls, etc.

Having described certain embodiments of the invention, it should be understood that the invention is not limited to the above description or the attached exemplary drawings. Rather, the scope of the invention is defined by the claims appearing hereinbelow and any equivalents thereof as would be appreciated by one of ordinary skill in the art.

What is claimed is:

1. A system of tracking, quantifying, and standardizing community service activity among a plurality of participants and service organizations, comprising:
a central and remotely accessible tracking system disposed on at least one central computer, including:
a points tracking module adapted to receive logs of community service activity from participants and convert said logs into numerical values corresponding to said community service activity;
a database in communication with said points tracking module adapted to accumulate said numerical values and sort said numerical values at least by respective of said participants who entered said logs; and
a first interface, remotely accessible by said participants and in communication with said points tracking module, adapted to enable said participants to enter said logs of community service activity.

2. A system of tracking, quantifying, and standardizing community service activity according to claim 1, wherein said database is further adapted to sort said numerical values by at least one of: i) a grouping of said participants or ii) said service organizations on behalf of which said community service activity was performed.

3. A system of tracking, quantifying, and standardizing community service activity according to claim 2, wherein said grouping is by at least one of demography, geography, or class.

4. A system of tracking, quantifying, and standardizing community service activity according to claim 1, wherein said database is in communication with said first interface and further enables said participants to select from a plurality of said service organizations for which said participants wish to perform said community service activity.

5. A system of tracking, quantifying, and standardizing community service activity according to claim 4, wherein said first interface comprises an account section informing said participant how much community service activity said participant has logged in said system.

6. A system of tracking, quantifying, and standardizing community service activity according to claim 5, wherein said account section informs said participant of said numerical values assigned to said logs of community service activity.

7. A system of tracking, quantifying, and standardizing community service activity according to claim 1, said central tracking system further comprising:
a second interface, remotely accessible by supervisors of said participants and in communication with said points tracking module, adapted to enable said supervisors to view and approve or reject said logs of community service activity entered by said participants.

8. A system of tracking, quantifying, and standardizing community service activity according to claim 1, further comprising a second interface, remotely accessible by said service organizations and in communication with at least one of said points tracking module and said database, adapted to enable said service organizations to monitor progress of said participants.

9. A system of tracking, quantifying, and standardizing community service activity according to claim 8, wherein said second interface is further adapted to enable said service organizations to create service projects storable on said database from which said participants may select to perform said community service activity.

10. A system of tracking, quantifying, and standardizing community service activity according to claim 7, further comprising a third interface, remotely accessible by said service organizations and in communication with at least one of said points tracking module and said database, adapted to enable said service organizations to monitor progress of said participants.

11. A system of tracking, quantifying, and standardizing community service activity according to claim 10, wherein said third interface is further adapted to enable said service organizations to create service projects storable on said database from which said participants may select to perform said community service activity.

12. A system of tracking, quantifying, and standardizing community service activity according to claim 1, said central tracking system further comprising:
a second interface, remotely accessible by third party data requesters and in communication with at least said database, adapted to enable said third party data requesters to view at least one of said logs of community service activity or said numerical values, corresponding to selectable of said participants.

13. A system of tracking, quantifying, and standardizing community service activity according to claim 7, said central tracking system further comprising:
a third interface, remotely accessible by third party data requesters and in communication with at least said database, adapted to enable said third party data requesters to view at least one of said logs of community service activity or said numerical values, corresponding to selectable of said participants.

14. A system of tracking, quantifying, and standardizing community service activity according to claim 9, said central tracking system further comprising:
a third interface, remotely accessible by third party data requesters and in communication with at least said database, adapted to enable said third party data requesters to view at least one of said logs of community service activity or said numerical values, corresponding to selectable of said participants.

15. A system of tracking, quantifying, and standardizing community service activity according to claim 11, said central tracking system further comprising:
a fourth interface, remotely accessible by third party data requesters and in communication with at least said database, adapted to enable said third party data requesters to view at least one of said logs of community service activity or said numerical values, corresponding to selectable of said participants.

16. A system of tracking, quantifying, and standardizing community service activity according to claim 1, wherein said points tracking module assigns different numerical values to different community service activities.

17. A system of tracking, quantifying, and standardizing community service activity according to claim 1, said points tracking module further comprising a qualitative points weight manager adapted to enable adjustment of said numerical values by at least one of supervisors of said participants or said service organizations.

18. A system of tracking, quantifying, and standardizing community service activity according to claim 17, wherein said qualitative points weight manager enables adjustment of said numerical values for different of said participants based on at least one variable associated with said participants.

19. A system of tracking, quantifying, and standardizing community service activity according to claim 18, said first interface further comprising a reflection tool enabling said participants to record subjective experiences associated with said logged community service activity, wherein said numerical values are adjustable via said qualitative points weight manager based on said recorded experiences.

20. A system of tracking, quantifying, and standardizing community service activity according to claim 17, further comprising institutional profiles stored on said database, said profiles containing instructions to pre-weight preferred community service activities.

21. A system of tracking, quantifying, and standardizing community service activity according to claim 7, further comprising institutional profiles stored on said database, said profiles containing instructions to pre-weight preferred community service activities, wherein said profiles are remotely configurable by said supervisors via said second interface.

22. A system of tracking, quantifying, and standardizing community service activity according to claim 8, further comprising institutional profiles stored on said database, said profiles containing instructions to pre-weight preferred community service activities, wherein said profiles are remotely configurable by said service organizations via said second interface.

23. A system of tracking, quantifying, and standardizing community service activity according to claim 12, further comprising institutional profiles stored on said database, said profiles containing instructions to pre-weight preferred community service activities, wherein said profiles are remotely configurable by said third party data requesters via said second interface.

24. A system of tracking, quantifying, and standardizing community service activity according to claim 1, wherein said numerical values represent length of time spent on said community service activity by said participant.

25. A system of tracking, quantifying, and standardizing community service activity according to claim 17, wherein said numerical values represent length of time spent on said community service activity by said participant prior to adjustment by said qualitative points weight manager.
